(19) United States
(12) Patent Application Publication
(10) Pub. No.: US 2008/0107275 A1
(43) Pub. Date: May 8, 2008

(54) Method and system for encryption of information stored in an external nonvolatile memory

(76) Inventor: Mehdi Asnaashari, Danville, CA (US)

Correspondence Address: Maryam Imam, Esq.;LAW OFFICES OF IMAM, Suite 1010, 111 North Market St., San Jose, CA, 95113, US

(21) Appl. No.: 11/598,173

(22) Filed: Nov. 8, 2006

(51) Int. Cl. H04L 9/08

(52) U.S. Cl. 380/281

(57) ABSTRACT

A nonvolatile storage system is described that includes a controller for transferring information between a host and nonvolatile memory. The controller includes an encryption/decryption engine for transferring information to and from a nonvolatile memory device, located externally to the controller, using a first key to encrypt information being stored into the nonvolatile memory device prior to storage thereof and further using the first key to decrypt the stored encrypted information after retrieval of thereof. Alternatively, a second key is used in conjunction with the first key to add further security to the information stored within the nonvolatile memory.

### BACKGROUND OF THE INVENTION

1. Field of the Invention

Embodiments of the present invention relate generally to nonvolatile memory systems and particularly to such systems having a controller for securely storing and accessing information to and from an external nonvolatile storage device.

2. Background

In recent years, nonvolatile memory has gained particular notoriety as a favorable storage medium due to its numerous characteristics, such as retention of stored information even when no power is provided. On the other hand and almost as a result thereof, storage of information, in a secure manner, incapable of being discovered by unauthorized sources, has become vitally important in a world dominated by the Internet, electronic commerce and greater requirements for electronic storage of sensitive information.

For example, passwords, user identifications allowing electronic access of information and electronic certificates have become sensitive information largely because they allow access to financial data and other confidential information. Thus, information storage and retrieval into and out of nonvolatile memory is desirable particularly if it is done securely. This is even more pronounced with respect to nonvolatile memory of large sizes, such as over one megabyte.

In some applications, devices, such as Smartcards and Trusted Platform modules (TPMs), include embedded flash or electrically programmable read-only-memory EPROM, which are particular types of nonvolatile memory. It is desirable to have these and other applications employ large nonvolatile memory. Nonvolatile memory is often employed for storing sensitive matter. Currently however, information leaving an electronic integrated circuit or device for storage into nonvolatile memory or flash devices does not enjoy heightened security and is therefore vulnerable to intrusion.

There are systems currently employing encryption/decryption techniques for accessing and programming information stored in nonvolatile memory, however, these systems include nonvolatile memory within a controller or integrated circuit and are thus not well suited for storage of mass information or storage of large volumes of information.

Additionally, it is very costly to include large nonvolatile memory inside of an integrated circuit, device or chip because the cost of manufacturing nonvolatile memory, due to integration, is significantly higher than manufacturing a device or chip in standard CMOS logic technology. As an example, including a large flash memory within the same integrated circuit as that including a controller or device has been known to increase costs by 25 to 30%. To include a relatively small-sized nonvolatile memory, such as in the order of bytes, can be done using CMOS logic technology. Nonvolatile memory cells implemented in CMOS logic technology are significantly larger than their counter parts cells implemented in electrically erasable programmable ROM (EEPROM) technology. However, cost of manufacturing of a device or chip in CMOS is significantly lower than that of EEPROM. A device or chip with small nonvolatile memory, manufactured using CMOS logic technology, experiences insignificant cost increases due to the larger CMOS nonvolatile memory cells required for nonvolatile memory. This, in turn, makes the device or chip a bit larger, however the cost is significantly lower than if the device or chip had to be implemented using EEPROM technology. A larger die size is tolerable if the increase in size is fairly insignificant but when memory of greater capacity is required, the increase in the size of the die is certainly not practical and EEPROM technology need be employed.

In applications where nonvolatile memory is located externally to the controller, i.e. on a different die, integrated circuit or chip or a different package, there are no effectively secure systems of storing and retrieving information to and from the external nonvolatile memory.

In light of the foregoing, the need arises for a nonvolatile storage system including a controller for effectuating a secure medium of information storage with the medium residing externally to the controller.

### IN THE DRAWINGS

FIG. 1(a) shows a nonvolatile memory system in accordance with an embodiment of the present invention.

FIG. 1(b) shows further details of the controller of the system of FIG. 1(a).

FIG. 2(c) shows an example embodiment of testing/manufacturing the controller of FIG. 1(a).

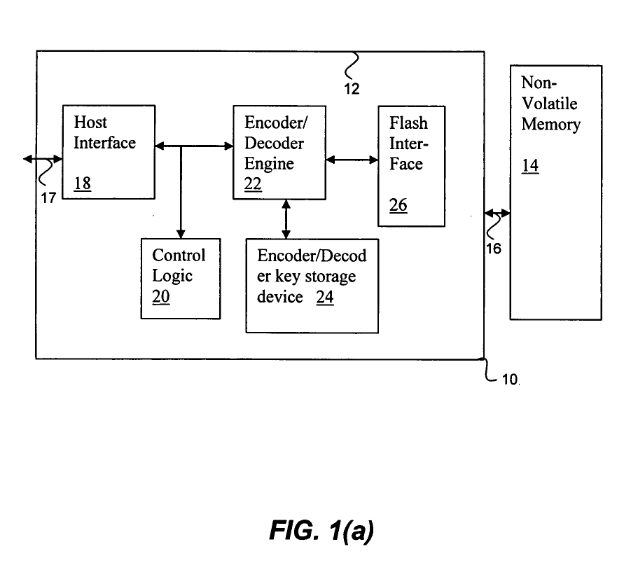

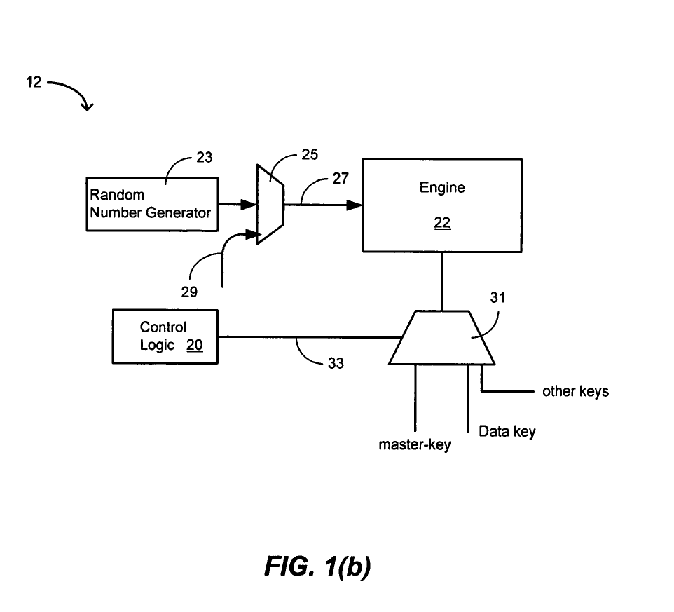

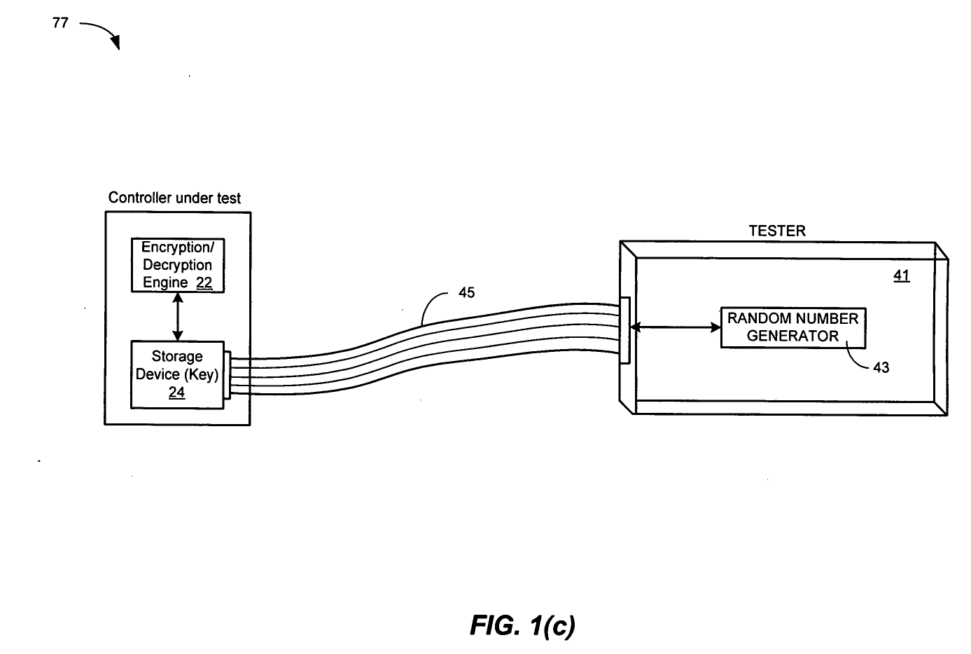

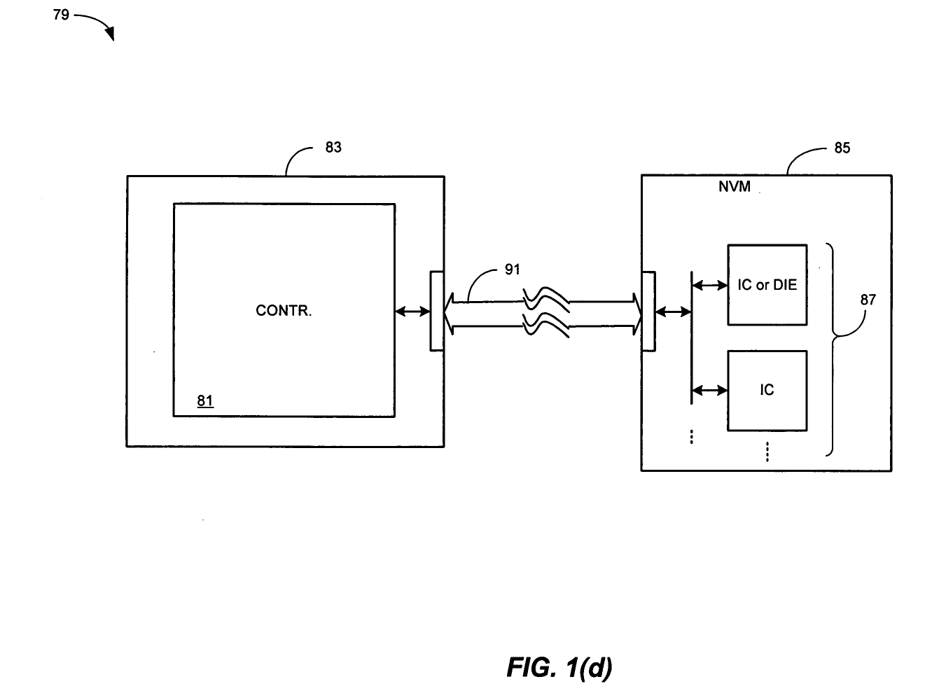

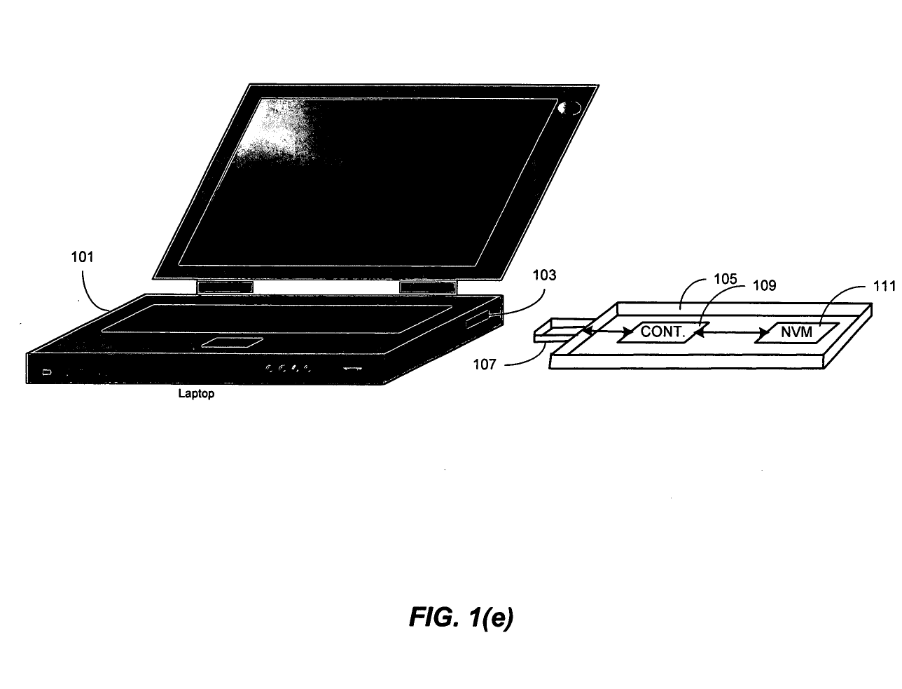

FIG. 1(d) shows an example embodiment of a nonvolatile system 79 in accordance with another embodiment of the present invention.

FIG. 1(e) shows an exemplary application of any of the foregoing nonvolatile memory systems, such as the nonvolatile system of FIG. 1(a).

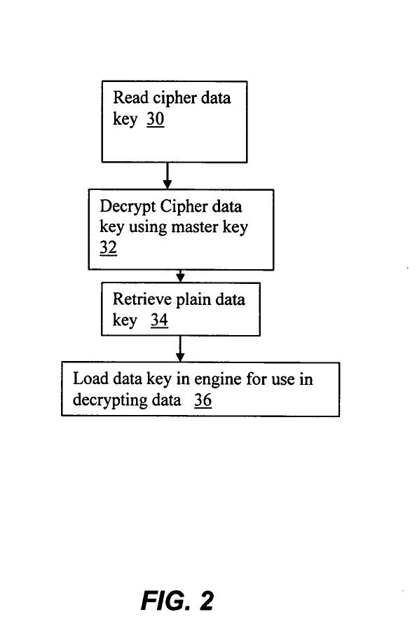

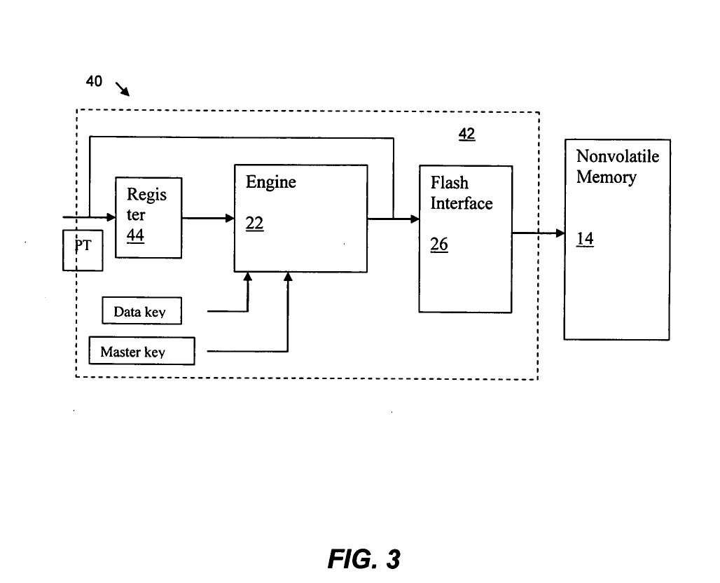

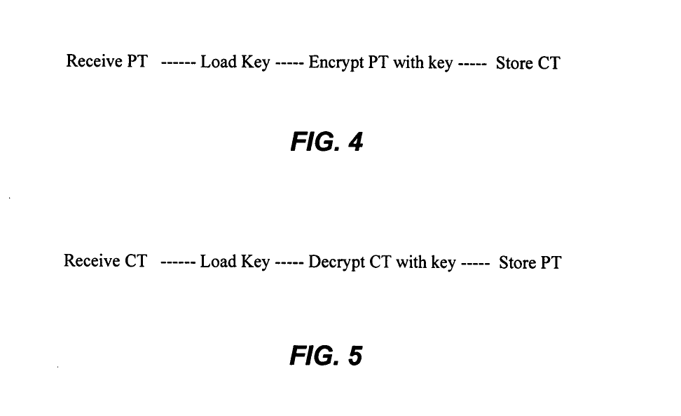

FIG. 2 shows example steps employed by the system of FIG. 1(a) in retrieving information stored in the nonvolatile memory.

FIG. 3 shows a nonvolatile memory system in accordance with another embodiment of the present invention.

FIG. 4 shows a flow chart of example steps processed in one embodiment when information is stored into nonvolatile memory.

FIG. 5 shows a flow chart of example steps processed in one embodiment when information is retrieved from nonvolatile memory.

### DETAILED DESCRIPTION OF THE PREFERRED EMBODIMENTS

Referring now to FIG. 1(a), a nonvolatile memory system 10 is shown, in accordance with an embodiment of the present invention, to include a controller 12 coupled to nonvolatile memory 14 through an interface (or communication link). 16. The link 16 can take on various forms, well known in the industry, such as flash interface, SPI, 12C, NOR and Nand flash busses, busses defined to conform to an-industry adopted standard, or the like. “Nonvolatile memory”, as used herein, refers to memory capable of retaining information when no power is supplied thereto. “Nonvolatile semiconductor memory”, as used herein, refers to semiconductor memory, made on a substrate, capable of retaining information when no power is supplied thereto. Semiconductor is made on substrate and nonvolatile semiconductor memory can be made in one or more die, chip or integrated circuit.

The controller 12 is shown to include a host interface 18, a control logic 20, an encoder/decoder engine 22, an encoder/decoder key storage device 24 and a flash interface 26. “Key”, as used herein, refers to an electronic value developed for the purposes of encrypting and/or decrypting information.

The host interface 18 is shown coupled to receive information from a host (not shown) through the host link 17, which in one example, is a universal serial bus (USB) connection and in other embodiments may be other known types of connection. Examples of devices serving as a host are the central processing unit (CPU) of a computer, the processing unit of a digital camera, a mobile communication device, such as a cell phone, and many others directing information into and out of nonvolatile memory. The host interface 18 is further shown coupled to the control logic 20 for providing thereto information received from the host.

Additionally, the host interface 18 is shown coupled to the engine 22 for providing information received from the host. The control logic 20 retrieves a master key, a key unique to a nonvolatile memory system, from the storage device 24, and loads the master key into the engine 22 for use in encrypting and/or decrypting information, which will become further evident shortly.

The control logic 20 is further shown coupled to the storage device 24 for maintaining a master key. The storage device 24, in one embodiment of the present invention, is nonvolatile memory. In an alternative embodiment, the master key is hard-wired, or permanently programmed or in read-only-memory (ROM). Examples of ways of hard-wiring the master key include but are not limited to the use of electrically programmable fuses, anti-fuses, laser blown and non-volatile memory cells. The master key may be alternatively programmed or stored within a ROM in the controller, by the firmware or software code. The master key may be optionally stored within the control logic 20 in which case the storage device 24 is unnecessary. In another embodiment, the master key is stored in the engine 22. Generation and programming of the master key takes place at the time of manufacturing of the controller 12 or system 10.

In the case where the storage device 24 is nonvolatile memory, the size of the controller 12 is slightly greater due to the use of CMOS process, but the increase in size is insignificant. This is because the size of the storage device 24 is on the order of bytes rendering the increase in size insignificant or negligible. However, the size of the nonvolatile memory 14 is significant and substantially increases the size and costs associated with the controller 12 if the nonvolatile memory 14 is placed within the controller 12. However, in accordance with embodiments of the present invention, the burden associated with greater sized nonvolatile memory 14 is eliminated by having the latter be located externally to the controller 12 thereby allowing for a practical use of CMOS process for the manufacturing of the controller 12.

Examples of the host link 17 include, but are not limited to USB, MultiMedia Card (MMC), Secure Data (SD), Compact Flash (CF), Memory Stick (MS), IDE, Serial ATA (SATA), PCI Express (PCIe), SCSI, ISO7816 and low pin count (LPC), which are industry-adopted standards.

The engine 22, which is used to encrypt and/or decrypt information, must be cryptographically strong, i.e. use encryption algorithms that have not been deciphered. Algorithms currently known to be strong, such as Advanced Encryption Standard (AES) 128/196/256, are programmably executed by the engine 22. It should be appreciated that any encryption/decryption algorithm may be employed without departing from the embodiments of the present invention. In one embodiment, the encryption/decryption algorithm is known not to be decipherable and thus, more secure.

In the event the encryption/decryption algorithm need be changed to a different algorithm, the engine 22 need be modified or replaced to accommodate such an algorithm change. The engine 22 is typically designed, using hardware, to implement a known yet indecipherable algorithm, in order to accomplish real-time encryption of information stored in nonvolatile memory. Alternatively, the engine 22 is programmed, using firmware or software, to implement an algorithm. It is appreciated however, that the firmware or software implementation of the engine 22 causes decreased speed in encryption/decryption. Thus, to implement encryption/decryption, in real-time, the engine 22 is designed in hardware and implements a known encryption/decryption algorithm.

The control logic 20 essentially controls the flow of information and may take on various forms, one of which is a central processing unit (CPU), as earlier noted. The engine 22 is further shown coupled to the storage unit 24 and the flash interface 26. The nonvolatile memory 14 may be included in one or more nonvolatile memory devices or integrated circuits (or chips).

In an example embodiment, as will be disused shortly, nonvolatile memory 14 may be in one or more integrated circuits with the circuits included in the same package as that of the controller 12 or in a physically externally located package.

In one embodiment of the present invention, the system 10 is a portable removable consumer device, as will be further discussed relative to subsequent figures that is connectable to a host for operation. Upon the connection of the system 10 to a host, a user of the system 10 or the portable removable consumer device is authenticated or authorized, at which time the master key is provided to the engine 22.

As stated hereinabove, the system 10 requires adequate and large-sized nonvolatile memory, such as the nonvolatile memory 14, for storing information or electronic data or other types of electronic information in a secure manner. Large size in intended to refer to nonvolatile memory that is economically and practically not feasible for inclusion within a die onto which other than nonvolatile memory is manufactured. Information to be stored is provided either by a host coupled to the device through a standard connection or by firmware included internally to the device or controller. Many example applications of such a device are anticipated, one of which is shown and discussed relative to FIG. 1(e).

It is understood that while most of the discussion and figures herein discuss information that is stored in the nonvolatile memory 14 (of FIG. 1(a)), or other nonvolatile memory in accordance with the embodiments of the present invention, as being in cipher text, or encrypted, information, that is not encrypted, or plain text, may also be stored within the nonvolatile memory. In the latter case, clearly, no decryption is required of the stored plain text. “Cipher text” (CT), as used herein, refers to an encrypted version of information. “Plain text” (PT), as used herein, refers to information in its raw form without any kind encryption. A “plain data key” is a data key that has not been encrypted or is decrypted. A “cipher data key” is an encrypted data key.

In operation, the host provides information to be stored into the nonvolatile memory 14, through the host link 17, to the host interface 18, which, in turn, couples the host-provided information to the control logic 20 and to the engine 22. Under the control of the control logic 20, the engine 22 receives the master key from the storage device 24 and uses the same to encrypt the host-provided information and passes the encrypted information, through the flash interface 26, to the nonvolatile memory 14.

When information is to be read from the nonvolatile memory 14, it is transferred, through the flash interface 26, to the engine 22, which uses the master key to decrypt the information transferred from the nonvolatile memory 24. In one embodiment of the present invention, the storage device 24 provides the master key to the engine 22. Use of the master key, by the engine 22, is performed under the direction of the control logic 20. The decrypted information is then provided by the engine 22 to the host interface 18, which, in turn, provides the same to the host.

In one embodiment, the master key is random and the engine 22 uses a relatively strong encryption/decryption algorithm in order to ensure security. In fact, during manufacturing of the controller 12, a random number generator generates the master key, which will be discussed relative to subsequent figures. It will be appreciated that less randomness of the master key and/or strength of the encryption/decryption code results in a less secure and more vulnerable state for the information stored or to be stored in the nonvolatile memory 14.

In this manner, the controller 12 (or system 10) has a unique personality in that each system is programmed using a different master key and the master key is and remains unknown to others. In fact, in the event the master key is purged, deleted or destroyed in some manner, the information stored in nonvolatile memory becomes useless because it cannot be decrypted. In the case of using a second key, such as a data key, as will be shortly discussed, in the event the data key is deleted or becomes unknown, the information stored in nonvolatile memory becomes useless but the system may be re-used for storing subsequent information although all previously stored information, stored using the lost data key, is forever lost. This is very helpful in keeping unauthorized access to stored information in the event the system or the nonvolatile memory operating with the system is lost.

In the event a master key is recovered by unauthorized means, the integrity of other systems (or controller 12), such as the system 10, is not compromised because each system has a unique master key. Various master keys are generated, by a tester, during manufacturing, and each generated master key is programmed into a different system 10 (or controller 12). Thus, the master key remains unknown to all even the designer of the system 10. For programmability of the master key, one-time-programmable memory, nonvolatile memory or fuse, among other devices, may be employed, in the storage device 24, because the master key need be programmed only one time and is thereafter only used by the system 10 (or controller 12). The master key is used throughout the lifetime of the system 10 (or controller 12).

A random number generator (not shown), generates a random number, in real-time or on-the-fly, during manufacturing of the system 10 (or controller 12), and the random number, which becomes the master key, is programmed into the system 10 (or controller 12). Thus, upon completion of manufacturing, the master key is stored in the storage device 24, which is preferably nonvolatile memory, fuse, one-time programmable memory or any other type of memory that can retain information when power is not applied. The master key is never changed or altered in any manner.

As an additional and optional measure of security, to secure the master key from being read, during manufacturing, a layer is inserted above the layer where the master key is programmed serving as a cap to hide the transistors of the storage device 24. In this way, an attempt to reveal the master key by taking the system 10 (or controller 12) apart, requires a level of sophistication in the absence of which failure to reveal occurs and additionally requires specialized equipment and high costs. It will be understood that some embodiments do not require obviscation of the programming means. That is, in some embodiments, the manner in which the master key is programmed into the system is not physically readable and does not require extra manufacturing steps to prevent unauthorized identification of the master key.

In one embodiment of the present invention, the nonvolatile memory 14 includes a predetermined storage location(s), referred to as a private area(s), for storage of private or sensitive information, such as certificate(s) and password(s), which is information other than that which a user of the system intended for storage. A private area is a predetermined location in nonvolatile memory for storing other than data intended to be stored by the user of the system 10. That is, certificates, passwords and the like are information other than that which the user intended to be stored but that is necessary for storage for proper functioning of the system.

In yet another embodiment of the present invention, a data key or second key is used to access information, offering added security of information. The master key is used to access only that information which is stored in the private area and within the private area, a data key is stored, in an encrypted fashion, and retrieved for accessing the remainder of the information within the nonvolatile memory.

To further clarify a method of operating the embodiment using two keys to retrieve information, a flow chart is shown, in FIG. 2, of example steps processed by the system 10 for accessing information using a master key and a data key. There may be one or more data keys, each data key for accessing a particular location in nonvolatile memory. The data key(s) are stored in the storage device 24, or in nonvolatile memory 14 in encrypted fashion. Alternatively, they are stored in the engine 22, in, for example, a register file or in any other locations within the controller 12.

FIG. 1(b) shows further details of the controller 12 of FIG. 1(a). In FIG. 1(b), the engine 22 is shown coupled to a random number generator 23, through a multiplexer (mux) 25, which receives a link 27, coupling the master key or data key, to the engine 22. The mux 25 allows the input of the engine 22 to selectively receive a key, through the link 27, or other information, through a data link 29. It is understood that in the case where the key is stored within the engine 22, the mux 25 is similarly located within the engine 22.

Further shown in FIG. 1(b), the control logic 20, of FIG. 1(a), is shown coupled to provide a select signal to a mux 31 that selectively receives a master key, a data key or other types of keys. In operation, in the case where a data or second key is to be generated, the control logic 20, through the select signal 33, signals the mux 31 to select the master key as its input and the engine 22 receives, through the link 27, a random number, generated by the random number generator. The engine 22 uses the master key to encrypt the received random number and to generate an encrypted (or cipher) data key. From this point on, the data key is employed, by the system 10, to encrypt and decrypt data intended, by the user, to be stored into nonvolatile memory. In the example embodiment where a private area is designated, the data key is encrypted and stored in the private area and is accessed using the master key.

During manufacturing, in an example embodiment, the random number generator 23 generates a random number to be used by the engine 22 in generating the master key. In this manner, the master key never leaves the controller 12 and is generated completely within the controller thereby enhancing security. Generally, security is comprised, at least on some level, when data or information leaves a chip, die or package because using test tools and stimulation devices, it is fairly easy to intercept the information after it leaves the chip as opposed to when it never does so.

FIG. 1(c) shows a controller testing apparatus 77 for testing/manufacturing the controller 12 of FIG. 1(a) that is different than that of the foregoing discussion relative to FIG. 1(b). In FIG. 1(c), a tester 41 is shown to test or aid in manufacturing of the controller 12 by programming the master key into the controller. Because the tester 41 is located externally to and physically outside of the controller 12, the master key is more vulnerable to interception. Accordingly, the security of the embodiment of FIG. 1(c) is less than that of the embodiment of FIG. 1(b) relative to generating and programming of the master key, thus, requiring a secure testing/manufacturing environment. In FIG. 1(c), a random number generator 43, located in the tester 41 generates and transfers a random number to serve as the master key, through the tester cable 45, to the engine 22 of the controller. The received master key is then stored in the controller in ways discussed above. It should be noted that in both of the embodiments 1(b) and 1(c), the master key is generated only once for each controller 12. Again, this is to further enhance the security level of the system in which the controller 12 is to be used, such as the system 10 of FIG. 1(a).

FIG. 1(d) shows an example embodiment of a nonvolatile system 79 including a controller 81 and nonvolatile memory 85 coupled through a communication link 91, wherein the controller 81 and the memory 85 are physically packaged in separate units. For example, the controller 81 is shown to be located in package 83, which does not include the nonvolatile memory 85. The communication link 91 physically connects the controller 83 and the nonvolatile memory 85. The nonvolatile memory 85 is shown to include one or more integrated circuits or die in the case where it is nonvolatile semiconductor memory. The system 79 of FIG. 1(d) is relatively less secure than the systems 10 of FIG. 1(a) and 40 of FIG. 3 because the encrypted information must travel outside of the controller package 83 and is easier to intercept albeit deciphering the information is just as difficult as the foregoing systems due to lack of knowledge of the relevant key.

FIG. 1(e) shows an exemplary application of any of the foregoing nonvolatile memory systems, such as the system 10. In FIG. 1(e), a notebook computer 101 is shown to receive a portable removable consumer device 105, at its port 103 with a connector 107 of the device 105 being removably connected thereto. The device 105 is shown to include a controller 109 coupled to nonvolatile memory 111.

The controller 109 communicates with a host in the computer 101 when the device 105 is connected thereto, through its connector 107. The controller 109 transfers information between the host and the nonvolatile memory, as discussed hereinabove. For example, a user of the computer 101 may wish to store information, such as files, into the device 105. The information is transferred through the port 103 and the connector 107 to the controller 109 wherein the information is encrypted, in the manner discussed earlier, using a key. The encrypted information (or cipher text) is stored in the nonvolatile memory 111. Similarly, when the user of the computer 101 wishes to read information previously stored in the device 105, the stored encrypted information is read from the nonvolatile memory 111, by the controller, decrypted into plain text, and provided, through the connector 107 and the port 103, to the computer 101.

In one example, the device 105 is the system 10 of FIG. 1(a). Alternatively, the device 105 does not include nonvolatile memory, which is packaged separately, as discussed relative to FIG. 1(d). In one exemplary embodiment, the port 103 and the connector 107 conform to the USB standard but other types of ways of communication may be employed in various embodiments of the present invention.

FIG. 2 shows example steps employed by the system 10 of FIG. 1(a) in retrieving information stored in the nonvolatile memory 14. In FIG. 2, at step 30, encrypted data key or cipher data key is read from the nonvolatile memory 14. The encrypted data key is preferably stored in a private area of the nonvolatile memory and the private area is accessed using either the master key or yet a third key generated by using the master key. Next, at step 32, the retrieved cipher data key is decrypted by the engine 22 using the master key, which is stored in the storage device 24. Next, at step 34, the retrieved, decrypted or plain text data key is loaded into the engine 22 and used to decrypt any data or information retrieved from anywhere other than the private area of the nonvolatile memory 14. In the case where two keys are employed, such as the foregoing example of using the master key and the data key, once the data key is retrieved at step 34, the master key need no longer be used unless other sensitive information, such as passwords or certificates, are to be accessed from or stored to the nonvolatile memory 14.

It should be noted that in alternative embodiments of the present invention, more than one private area may be designated within the nonvolatile memory 14, furthermore, each private area may be accessed by using a different data key. As long as keys can be securely stored, there is no limit as to the number of data keys being employed.

FIG. 3 shows a nonvolatile memory system 40 in accordance with another embodiment of the present invention. The nonvolatile memory 14 of FIG. 1(a) is shown coupled to a controller 42 including the engine 22 and the flash interface 26 of FIG. 1(a) but showing the engine to receive a master key and a data key. The controller 42 is shown to receive plain text, which is coupled to a register 44 for temporary storage thereof. The register 44 is shown coupled to the engine 22 and the latter is shown coupled to the flash interface 26 in the same manner as that of FIG. 1(a). The difference between the embodiment of FIG. 3 and that of FIG. 1(a) is that either plain text or cipher text may be selectively provided to the flash interface 26. In the case where PT is converted to CT, it is transferred from the register. 44 to the engine 22 for encryption thereof using optionally two keys, the master key and the data key. That is, as noted earlier, if the PT is sensitive information including a password, certificate, key and the like, the master key is used to encrypt it, otherwise, if it is data or what is sometimes referred to as user data, data other than password, certificate, key or the like, it is encrypted using a data key.

As shown in FIG. 3, the engine 22 may be bypassed but there would be insignificant security, at best, provided to information being stored to or retrieved from the nonvolatile memory 14.

The nonvolatile memory 14 may have a large storage capacity, i.e. more than 1 Megabyte. Locating the nonvolatile memory for storage of large information, externally to the controller allows manufacturing of the controller using CMOS technology, which is less expensive than the process used for manufacturing flash or other types of nonvolatile memory.

FIG. 4 shows a flow chart of example steps of one embodiment processed when information is stored into the nonvolatile memory 14 of FIG. 3. First, PT is received by the controller and a key is loaded into the engine 22. Next, PT is encrypted with the loaded key to generate a CT version of the PT and the former is saved or stored into the nonvolatile memory. The type of key used depends on whether a private area is designated within the nonvolatile memory and whether it is the private area to which CT is being stored. In the case of the latter, the master key is used as the key and in the case where two keys are being employed and an area other than the private area is being accessed, the data key is the key being used. In the case where a private area is not designate, then, clearly, the master key is used.

FIG. 5 shows a flow chart of example steps processed in another embodiment when information is retrieved from the nonvolatile memory 14 of FIG. 3. First, CT is received by the controller and a key is loaded into the engine 22. Next, the loaded key is used to decrypt the CT thereby retrieving the PT. Note that the same key is used for information to and from the same location when encrypting and decrypting, otherwise, decryption would not result in the accurate PT. As to which key is used in FIG. 5, the same situations as discussed relative to FIG. 4 apply to FIG. 5.

Although the present invention has been described in terms of specific embodiments, it is anticipated that alterations and modifications thereof will no doubt become apparent to those skilled in the art with the benefit of the present disclosure. It is therefore intended that the following claims be interpreted as covering all such alterations and modification as fall within the true spirit and scope of the invention.

What is claimed is:

1. A controller employed in a nonvolatile storage system for transferring information between a host and nonvolatile memory comprising:
an encryption/decryption engine for transferring information to and from the nonvolatile memory, located externally to the controller, wherein the engine uses a key to encrypt information to be stored into the nonvolatile memory device prior to storage therein and uses the key to decrypt encrypted information after retrieval from the nonvolatile memory.

2. A controller, as recited in claim 1, wherein the key is a master key.

3. A controller, as recited in claim 2, wherein an encrypted data key is stored, by the engine, into a predetermined location within the nonvolatile memory, the encrypted data key having been generated by the engine using the master key, the stored encrypted data key is retrieved from the predetermined location and decrypted by the engine using the master key and being used to decrypt information retrieved from the nonvolatile memory located in other than the predetermined location.

4. A controller, as recited in claim 3, further including a multiplexer adapted to selectively provide the master key and the data key to the engine.

5. A controller, as recited in claim 3, wherein the predetermined location is a private area for storing information other than data intended to be stored by a user of the system.

6. A controller, as recited in claim 5, wherein more than one private area are designated.

7. A controller, as recited in claim 6, wherein each of the private areas includes an encrypted data key unique thereto.

8. A controller, as recited in claim 7, further including a random number generator for generating a data key that is the unencrypted version of the encrypted data key.

9. A controller, as recited in claim 3, further including a random number generator for generating a random number adapted to be received by the engine for generating the encrypted data key.

10. A controller, as recited in claim 2, further including a random number generator for generating the master key.

11. A controller, as recited in claim 10, further including an encoder/decoder key storage device for storing the data key.

12. A controller, as recited in claim 11, further including a nonvolatile memory for storing a unique random number generated by the random number generator.

13. A controller, as recited in claim 1, further including an encoder/decoder key storage device for storing the master key.

14. A nonvolatile memory system comprising:
nonvolatile memory;
a controller coupled between a host and the nonvolatile memory for transferring information therebetween and being located externally to the nonvolatile memory, the controller including an encryption/decryption engine for transferring information, in cipher text, to the nonvolatile memory using a key to encrypt information being stored into the nonvolatile memory by generating the cipher text prior to storage and using providing plain text by using the key to decrypt the stored cipher text after retrieval of the stored information.

15. A nonvolatile memory system, as recited in claim 14, wherein the key is a master key.

16. A nonvolatile memory system, as recited in claim 14, wherein an encrypted data key is retrieved from a private area designated within the nonvolatile memory, the data key being decrypted by the engine and being used to decrypt information retrieved from the nonvolatile memory located other than in the private area.

17. A nonvolatile memory system, as recited in claim 14, wherein the controller includes one-time-programmable memory, nonvolatile memory, or fuse(s) for storing the data key.

18. A nonvolatile memory system, as recited in claim 14, wherein the controller includes one-time-programmable memory, nonvolatile memory, or fuse(s) for storing the master key.

19. A nonvolatile memory system, as recited in claim 14, wherein the nonvolatile memory is flash memory or hard disk drive.

20. A nonvolatile memory system, as recited in claim 14, wherein the nonvolatile memory includes nonvolatile semiconductor memory.

21. A nonvolatile memory system, as recited in claim 20, wherein the nonvolatile semiconductor memory is one or more integrated circuits.

22. A controller employed in a nonvolatile storage system for transferring information between a host and nonvolatile memory comprising:
an encryption/decryption engine for transferring information to and from a nonvolatile memory device, located externally to the controller, the engine for receiving plain text and using a key to generate a cipher text version of the received plain text for storage thereof into the nonvolatile memory device and upon retrieval of information, using the key to decrypt the cipher text to re-generate the plain text.

23. A controller, as recited in claim 22, wherein the key is a master key.

24. A controller, as recited in claim 22, wherein an encrypted data key is retrieved from a private area designated within the nonvolatile memory, the data key being decrypted by the engine and being used to decrypt information retrieved from the nonvolatile memory located other than in the private area.

25. A method of securely storing and accessing information to and from nonvolatile memory comprising:
receiving plain text;
encrypting plain text with a first key to generate cipher text;
storing the cipher text in nonvolatile memory located externally to where the cipher text is generated;
retrieving the stored cipher text; and
decrypting the retrieved cipher text using the first key.

26. A method of securely storing and accessing information, as recited in claim 25, further including the steps of:
storing an encrypted version of a second key into a predetermined area within the nonvolatile memory;
retrieving the encrypted second key;
using the master key to decrypt the second key; and
retrieving information from an area, other than the predetermined area, of the nonvolatile memory using the second key.

27. A method of manufacturing a controller comprising:
generating a master key unique to a controller being manufactured;
storing the generated master key in the controller;
encrypting information being stored, prior to storage, using the stored master key, the encrypted information being indecipherable by any known techniques;
storing the encrypted information;
reading the stored encrypted information; and
decrypting the stored encrypted information being read, using the stored master key.

28. A method of manufacturing a controller, as recited in claim 27, wherein performing the generation step in real-time.

29. A method of manufacturing a controller, as recited in claim 27, wherein performing the encryption step using AES.

30. A controller testing apparatus for testing a controller comprising:
a random number generator for generating a master key t unique to a portable removable consumer device; and
encryption/decryption engine for encrypting information being stored, prior to storage, using the master key and for decrypting encrypt information using the master key, the encrypted information being indecipherable by any known techniques.

31. A nonvolatile storage system for transferring information between a host and nonvolatile memory comprising:
nonvolatile memory;
communication link coupled to the nonvolatile memory; and
controller coupled to the nonvolatile memory, through the communication link, and packaged in the same unit as the nonvolatile memory and including an encryption/decryption engine for transferring information to and from the nonvolatile memory, located externally to the controller, wherein the engine uses a key to encrypt information to be stored into the nonvolatile memory device prior to storage therein and uses the key to decrypt encrypted information after retrieval from the nonvolatile memory.

32. A portable removable consumer device for transferring information between a host and nonvolatile memory comprising:
nonvolatile memory;
communication link coupled to the nonvolatile memory; and
controller coupled to the nonvolatile memory, through the communication link, and located externally to the nonvolatile memory and including an encryption/decryption engine for transferring information to and from the nonvolatile memory, the engine selectively receiving a key and using the same to encrypt information to be stored into the nonvolatile memory device prior to storage therein and using the key to decrypt encrypted information after retrieval from the nonvolatile memory.

33. A portable removable consumer device, as recited in claim 32, wherein the controller further includes a random number generator for generating a master key unique to the device and generated only once.

34. A portable removable consumer device, as recited in claim 32, wherein the random number generator is used to generate a second key, selectively employed by the engine to encrypt and decrypt information to and from the nonvolatile memory.

35. A portable removable consumer device, as recited in claim 34, wherein the engine for encrypting the second key to generate and store a cipher data key in a designated area of the nonvolatile memory.

36. A portable removable consumer device, as recited in claim 35, wherein the designated area is used to store information other than that intended to be stored by a user of the device.

37. A portable removable consumer device, as recited in claim 35, further including a key storage device coupled to the engine for storing the key.
